(19) United States
(12) Patent Application Publication
(10) Pub. No.: US 2007/0066389 A1
(43) Pub. Date: Mar. 22, 2007

(54) Gaming machine

(75) Inventor: Sakiko Kojima, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/509,808

(22) Filed: Aug. 25, 2006

(30) Foreign Application Priority Data
Aug. 26, 2005 (JP) 2005-245945

(51) Int. Cl. A63F 13/00

(52) U.S. Cl. 463/31

(57) ABSTRACT

According to the present invention, it is possible to provide a gaming machine in which a game player's expectation is maintained. The gaming machine comprises: a variable display device for displaying identification symbols variably and privilege symbols variably; a control device for determining whether or not a combination of identification symbols along a pay line matches a predetermined combination. The control device determines an amount of game value to be paid out to a player based on a payout rate and a privilege symbol displayed at a position corresponding to the pay line.

### CROSS REFERENCE TO RELATED APPLICATIONS

This application is based upon and claims the benefits of priorities from Japanese Patent Application No. 2005-245945 filed on Aug. 26, 2005, the entire contents of which are incorporated herein by reference.

### FIELD OF THE INVENTION

The present invention relates to a gaming machine and more specifically it relates to a gaming machine in which a multiplication lottery may be conducted with respect to a payout rate of a winning combination.

### RELATED ART

Recently, as the population of game players who are fond of playing games with newer gaming machines, many corporations which develop and manufacture gaming machines have developed a variety of gaming machines and put them into the market. Among such gaming machines, a type of gaming machine which comprises reels and provides a player with a certain amount of benefit based on a combination of symbols shown on the reels in a stationary manner may be exemplified. Since this kind of gaming machine may apply to a slot machine and a pachinko machine, the slot machine will be employed in this disclosure for the explanation purpose.

In general, the slot machine is a machine in which the player plays a game by betting a game value medium such as medal, coin and the like, and receives a corresponding amount of payout to a winning combination obtained as a result of the game. More specifically, the game of the slot machine is started by the player's operation of a start lever. Once the start lever is operated by the player, reels on which a plurality of symbols are drawn start to rotate and then the reels stop rotating and display symbols in a stationary manner. In this case, if a combination of symbols listed in a payout table is displayed along a pay line, a winning combination according to the displayed combination of symbols is established such that a certain amount of payout based on a winning content (the combination of symbols displayed along the pay line). Thus, the gaming machine provides a benefit to the player by paying out a corresponding number of coins into a receiving tray to the kind of winning combination, or by crediting the same number of coins to the deposit of the gaming machine.

As the result of pursuing such a gaming machine that can enhance the player's desire to play the game with such a general gaming machine as described above, a gaming machine which conducts a multiplication lottery for the payout amount has been developed (for example, refer to JP-A-2005-052379).

However, this machine does not have enough capability to maintain the player's expectation for the multiplication factor such that a gaming machine that can maintain the expectation during the game process is strongly desired.

### SUMMARY OF THE INVENTION

It is possible to provide a gaming machine that can maintain the player's expectation for the payout multiplication factor in the continuing game (e.g., during rotation of the reels).

The present invention may be characterized as described below. One of the aspects of the present invention may be exemplified as a gaming machine.

According to the present invention, a gaming machine comprises: a variable display device including an identification symbol display part for displaying identification symbols variably and stopping such variable display and a privilege symbol display part for displaying privilege symbols variably and stopping such variable display; and a control device for determining whether or not a combination of identification symbols being displayed along a pay line by the identification symbol variable display part matches a predetermined combination when the variable display of the identification symbols is stopped. The control device determines an award to a player based on a payout rate of the predetermined combination when the combination of identification symbols displayed along the pay line matches the predetermined combination, and a special benefit of a privilege symbol displayed at a position corresponding to the pay line by the privilege symbol variable display part when the variable display of the privilege symbols is stopped.

Further features of the present invention, its nature, and various advantages will be more apparent from the accompanying drawings and the following description of the preferred embodiment.

### BRIEF DESCRIPTION OF THE DRAWINGS

FIG. 1 is a perspective view showing a slot machine.

FIG. 2 is a longitudinal section view of a lower liquid crystal display and a reel.

FIG. 3 is an exploded perspective view of the lower liquid crystal display.

FIG. 4 is a block diagram showing a control system of the slot machine schematically.

FIG. 5 is a block diagram showing schematically a liquid crystal driving circuit of the lower liquid crystal display.

FIG. 6 is a diagram showing an example of an array of symbols to be displayed in variable display parts.

FIG. 7 is a diagram showing an example of an array of symbols to be displayed in a multiplication display part.

FIG. 8 is a functional block diagram showing the control system of the slot machine.

FIG. 9 is a flowchart showing an example of a main process.

FIG. 10 is a flowchart showing an example of a start acceptance process.

FIG. 11 is a flowchart showing an example of a base game process.

FIG. 12 is a flowchart showing an example of a lottery process.

FIG. 13 is a flowchart showing an example of a bonus game process.

FIG. 14 is a flowchart showing an example of a free-spin process.

FIG. 15 is a diagram showing an example of the content which is displayed on the lower liquid crystal display.

FIG. 16 is a diagram showing an example of the content which is displayed on the lower liquid crystal display subsequent to the content of FIG. 15.

FIG. 17 is a diagram showing an example of the content which is displayed on the lower liquid crystal display subsequent to the content of FIG. 16.

FIG. 18 is a diagram showing an example of the content which is displayed on the lower liquid crystal display subsequent to the content of FIG. 17.

FIG. 19 is a diagram showing an example of the content which is displayed on the lower liquid crystal display.

FIG. 20 is a diagram showing an example of the content which is displayed on the lower liquid crystal display subsequent to the content of FIG. 19.

FIG. 21 is a diagram showing an example of the content which is displayed on the lower liquid crystal display subsequent to the content of FIG. 20.

FIG. 22 is a diagram showing an example of the content which is displayed on the lower liquid crystal display subsequent to the content of FIG. 21.

### DESCRIPTION OF THE PREFERRED EMBODIMENT

Hereafter, a gaming machine which is exemplified in a slot machine will be explained in detail in reference to the attached drawings according to an embodiment of the present invention.

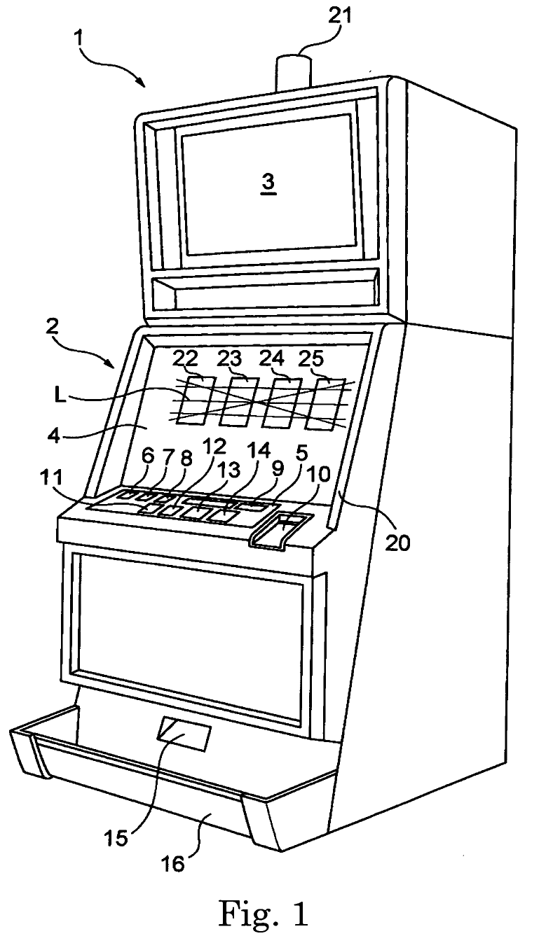

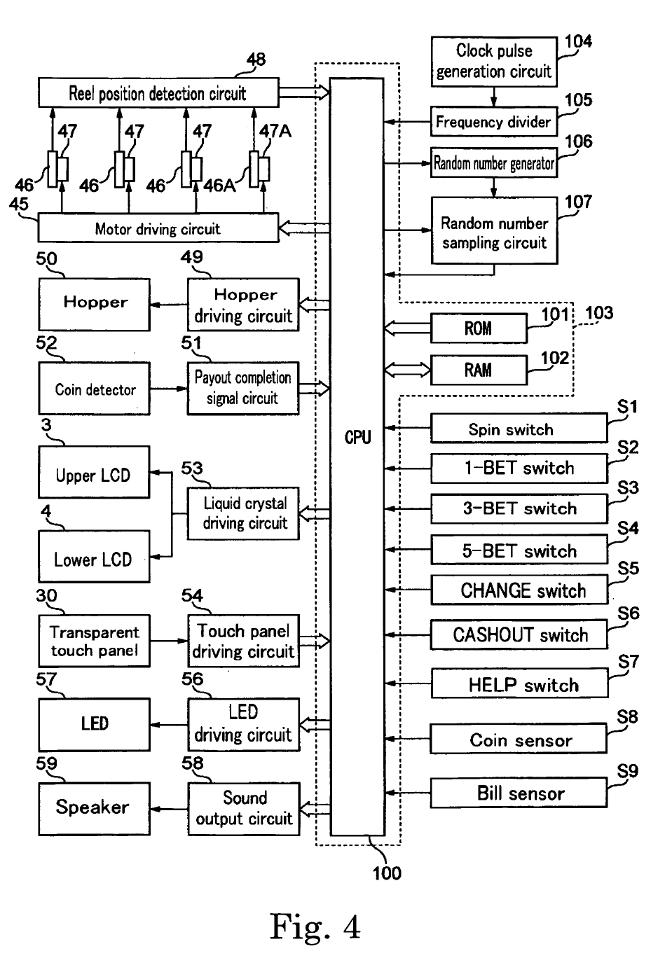

First, an explanation will be made for a general configuration of the slot machine according to the embodiment of the present invention by referring to FIGS. 1 and 4. FIG. 1 is a perspective view showing the slot machine. FIG. 4 is a block diagram showing a control system of the slot machine schematically.

[1. General Configuration of Slot Machine]

As shown in FIG. 1, the slot machine 1 is provided with a cabinet 2 which forms an outer shape of the slot machine. The slot machine 1 is provided with a lamp 21 which is disposed on the top face of the cabinet 2. Also, an upper liquid crystal display 3 is disposed on the front face of the upper part of the cabinet 2. Further, a lower liquid crystal display 4 is disposed on the front face of the center part of the cabinet 2. The upper liquid crystal display 3 is composed of a commercially available liquid crystal display to be used for a general purpose. And the lower liquid crystal display 4 is composed of a so-called transparent liquid crystal display. On the upper liquid crystal display 3, game-related information which includes how to play the game, kinds of winning combinations and payout rates thereof, and various kinds of effects of the game is displayed. On the other hand, as shown in FIG. 1, the lower liquid crystal display 4 is basically provided with variable display parts 22, 23, and 24. Thus, various kinds of identification symbols formed on each reel 46 (refer to FIG. 4) to be described later are variably displayed as they are scrolled from top to bottom in each of the variable display parts 22 through 24 according to the rotation of the reel 46. And multiplication display part 25 is provided to the left of the variable display part 24. In the multiplication display part 25, various kinds of multiplication symbols formed on each reel 46A (refer to FIG. 4) to be described later are variably displayed as they are scrolled from top to bottom as the reel 46A is rotated. As well, the configuration of the lower liquid crystal display 4 will be described later in detail.

An operation table 5, projecting forward from the front of the cabinet 2, is provided below the lower liquid crystal display 4. A CHANGE button 6 (for changes), a payout (CASHOUT) button 7 (for payout), and a HELP button 8 (for help information) are disposed from left to right on the operation table 5. Also, a coin insertion slot 9 and a bill insertion slot 10 are provided on the right side of the help button 8. Further, a 1-BET button 11, a spin (SPIN/REPEAT-BET) button 12, a 3-BET button 13, and a 5-BET button 14 are disposed from left to right in the front row on the operation table 5. In the slot machine, the CHANGE button 6 is a button to turn on the lamp 21. To the CHANGE button 6, a CHANGE switch S5 (for changes) is attached such that a switch signal is outputted from the CHANGE switch S5 to the CPU 100 based on depression of the CHANGE button 6.

The payout (CASHOUT) button 7 is a button to be depressed at the end of a base game. Upon depression of the payout (CASHOUT) button 7, coins having been gained in the game are paid out from a coin payout opening 15 to a coin receiving part 16. The payout (CASHOUT) button 7 is provided with a payout (CASHOUT) switch S6. Upon depression of the payout (CASHOUT) button 7, the payout (CASHOUT) switch S6 outputs a switch signal to the CPU 100. The help button 8 is a button to be depressed when the player is not sure about operations of the game and so on. Upon depression of the help button 8, various kind of help information is displayed on the upper liquid crystal display 3 and/or the lower liquid crystal display 4. To the help button 8, a help switch S7 is attached such that a switch signal is outputted from the help switch S7 to the CPU 100 upon depression of the help button 8.

The coin insertion slot 9 is provided with a coin sensor S8 such that a coin detection signal is outputted to the CPU 100 though the coin sensor S8 upon insertion of a coin into the coin insertion slot. Also, the bill insertion slot 10 is provided with a bill sensor S9 such that a bill detection signal is outputted to the CPU 100 though the bill sensor S9 upon insertion of a bill into the bill insertion slot 10. The 1-BET button 11 is a button to be pressed for betting one by one at every single time of depression of the button. The 1-BET button 11 is provided with a 1-BET switch S2 such that a switch signal is outputted from the 1-BET switch S2 to the CPU 100 upon depression of the 1-BET button. The spin (SPIN/REPEAT-BET) button 12 is a button to be pressed for starting the game with the current or previous bet number such that a variable display of identification symbols in the variable display parts 22 through 24 and a variable display of multiplication symbols in the multiplication display part 25 of the lower liquid crystal display 4 are started upon depression of the spin button 12. The spin button 12 is provided with a spin switch S1 such that a switch signal is outputted from the spin switch S1 to the CPU 100 upon depression of the spin button 12. Here, the possible bet number of betting by depression of the spin button 12 may include 1, 2, 3, 4, and 5.

The 3-BET button 13 is a button to be pressed for starting the game with 3 bets upon depression of the button. The 3-BET button 13 is provided with a 3-BET switch S3 such that a switch signal is outputted from the 3-BET switch S3 to the CPU 100 upon depression of the 3-BET button 13. Also, the 5-BET button 14 is a button to be pressed for starting the game with 5 bets upon depression of the button. The 5-BET button 14 is provided with a 5-BET switch S4 such that a switch signal is outputted from the 5-BET switch S4 to the CPU 100 upon depression of the 5-BET button 14. Further, the slot machine is provided with the coin payout opening 15 and the coin receiving part 16 to receive paid out coins at the bottom of the cabinet 2. A coin detector 52, composed of a sensor and so on as described later, is disposed inside the coin payout opening 15. The coin detector 52 detects the number of coins to be paid out from the coin payout opening 15.

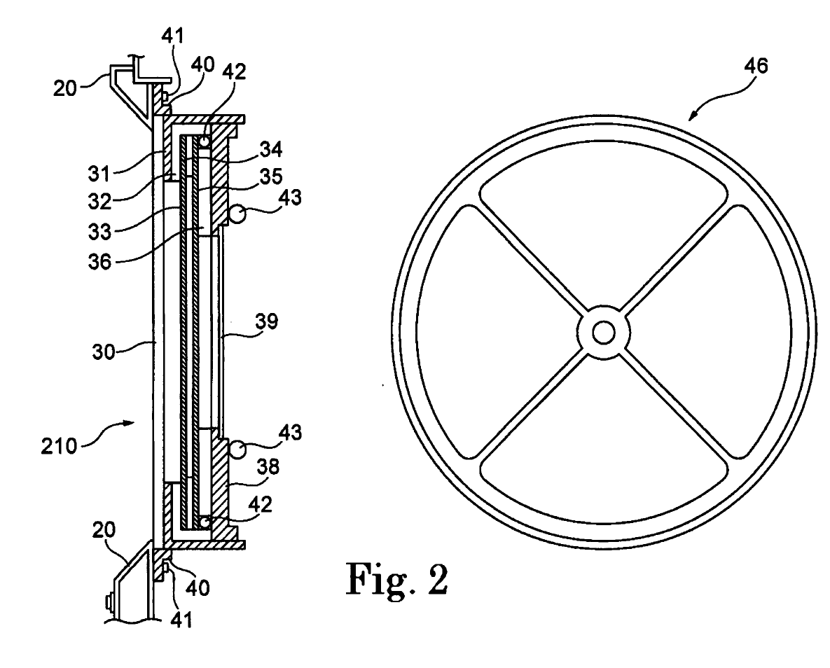

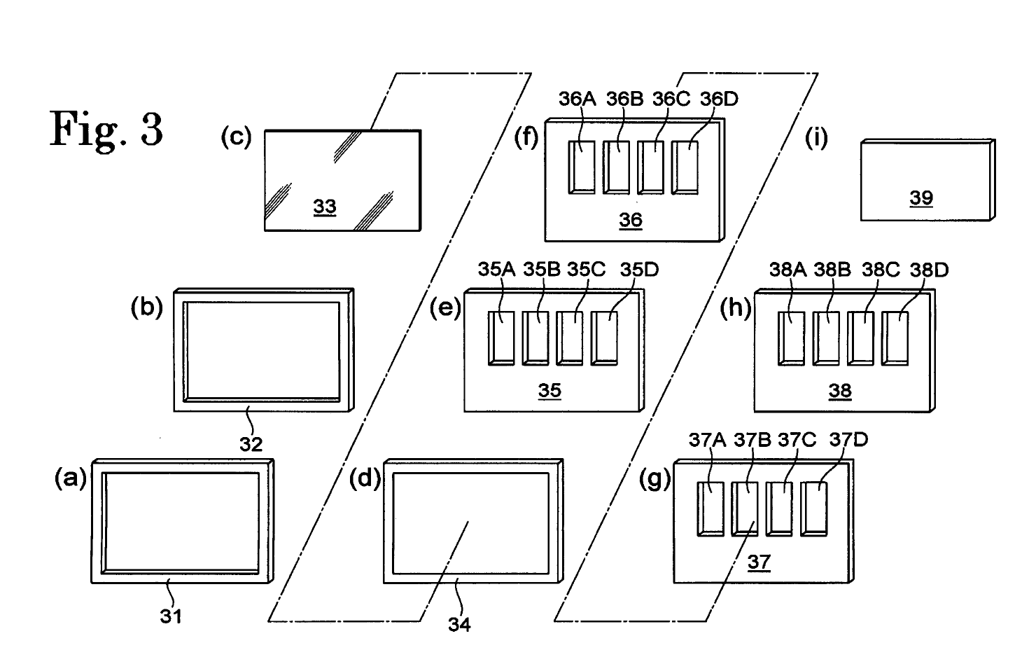

Next, by referring to FIGS. 2 and 3, an explanation will be made for the detailed configuration of the lower liquid crystal display 4 and reels which are rotatably fixed on the back side of the lower liquid crystal display 4 inside of the cabinet 2A. FIG. 2 is a longitudinal section view of the lower liquid crystal display 4 and one of the reels, and FIG. 3 is an exploded perspective view of the lower liquid crystal display 4. As shown in FIGS. 2 and 3, the lower liquid crystal display 4 is disposed inside of a display window unit 210 of the machine front panel 20 being disposed at the front center part of the cabinet 2 of the slot machine 1 along with a transparent touch panel 30 which is disposed on the front face (on the left side in FIG. 2) of the lower liquid crystal display 4. Further, on the back side of the lower liquid crystal display 4 (on the right side in FIG. 2), the three reels 46, 46, 46 (only one of them is shown in FIG. 2) and the reel 46A, which has multiplication symbols on the outer peripheral surface, are arranged in parallel and supported in an independently-rotatable manner, respectively. Therefore, as shown in FIG. 2, the lower liquid crystal display 4 is disposed in front of the three reels 46, 46, 46 for displaying identification symbols variably and the reel 46A for displaying multiplication symbols variably. Thus, the base game to be described later is conducted with the respective three reels 46, 46, 46 and the reel 46A that can be seen through the lower liquid crystal display 4.

Here, an explanation will be made for the respective three reels 46, 46, 46. The left reel 46 among the three reels 46, 46, 46, provided on the left side in the front view of the slot machine 1, is opposed to the variable display part 22 (refer to FIG. 1) which is formed on the lower liquid crystal display 4. And the center reel 46, provided at the center of the three reels, is opposed to the variable display part 23 (refer to FIG. 1) which is formed on the lower liquid crystal display 4. Similarly, the right reel 46, provided on the right side of the three reels, is opposed to the variable display part 24 (refer to FIG. 1) which is formed on the lower liquid crystal display 4. Further, the configuration of the variable display parts 22 through 24 will be described later.

Then, by referring to FIGS. 2 and 3, an explanation will be made for the configuration of the lower liquid crystal display 4. As shown in FIGS. 2 and 3, the lower liquid crystal display 4 is configured in such a way that the transparent touch panel 30, a reel glass base 31, a bezel metal frame 32, a liquid crystal panel 33, a liquid crystal holder 34, a diffusion sheet 35, a light guide plate 36, a white-color reflector 37, a rear holder 38, and a antistatic sheet 39 are disposed in this order from the front side of the slot machine 1. Openings 35A, 35B, 35C, 35D are formed in the diffusion sheet 35. Similarly, openings 36A, 36B, 36C, 36D; openings 37A, 37B, 37C, 37D; and openings 38A, 38B, 38C, 38D are formed in the light guide plate 36, the reflector 37, and the rear holder 38, respectively, such that they coincide with the openings 35A, 35B, 35C, 35D. Openings 35A through 38A are arranged in an overlapping manner so as to coincide with each other and configure the variable display part 22 (refer to FIG. 1). Similarly, openings 35B through 38B configure the variable display part 23 (refer to FIG. 1), and openings 35C through 38C configure the variable display part 24 (refer to FIG. 1). The variable display parts 22, 23, 24 may be equivalent to or included by variable display means for the identification symbols of the present invention. Also, openings 35D through 38D configure the multiplication display part 25 (refer to FIG. 1) which may be equivalent to or included by a variable display mean for privilege symbols of the present invention. Here, openings 35A through 35D of the diffusion sheet 35 and openings 36A through 36D of the light guide plate 36 configure transparent areas which ensure visibility of the variable display parts 22 through 24 and the multiplication display part 25, respectively.

As shown in FIG. 2, the lower liquid crystal display 4 is attached to the display window unit 210 of the device front panel 20 such that the reel glass base 31 is fixed between top and bottom brackets 40 that are screwed onto the back side face of the device front panel 20 with screws 41. Further, on the top and bottom edges of the light guide plate 36, a couple of cathode-ray tubes 42 are provided as light sources of the liquid crystal panel 33. In addition, above and below the openings 38A through 38D, a couple of cold cathode-ray tubes 43 are provided on the back side of the rear holder 38 in order to light up symbols formed on respective outer peripheral surfaces of the three reels 46, 46, 46. The liquid crystal panel 33, disposed in front of each reel 46 that can be seen therethrough, is composed of a transparent electrical display panel which is made of ITO (indium tin oxide) or the like and is supported by the liquid crystal holder 34 around a peripheral area of a display part thereof on the back side. The light guide plate 36 is composed of an optically transmissive plastic panel, and is subject to lens cut in order to introduce light emitted from the cold cathode-ray tubes 42 being positioned on the edge thereof to the back side of the liquid crystal panel 33. The diffusion sheet 35, composed of an optically transmissive plastic panel, diffuses light introduced by the light guide plate 36 in order to homogenize light irradiating the liquid crystal panel 33. The liquid crystal holder 34 which holds the liquid crystal panel 33, the diffusion sheet 35 and the light guide plate 36 are integrated such that a periphery thereof is inserted into the bezel metal frame 32. Thus, this insertion makes the bezel metal frame 32 hold the front side of the display part of the liquid crystal panel 33 held.

The liquid crystal holder 34, the diffusion sheet 35 and the light guide plate 36 which are integrated and a periphery of the integrated is inserted into the bezel metal frame 32 and the reel glass base 31 holds it in a manner that a front face of the display part of the liquid crystal panel 33 is open. By fixing the reel glass base 31 to the device front panel 20 with the screws 41, the transparent touch panel 30 is pressed onto the front face of the reel glass base 31 and is overlaid on the front side of the display part of the liquid crystal panel 33. The rear holder 38, being composed of a white resin plate, holds the bezel metal frame 32 supported by the reel glass base 31, the liquid crystal holder 34 framing the liquid crystal panel 33, the diffusion sheet 35 and the light guide panel 36 on the back side thereof with the reel glass base 31. This rear holder 38 also works as a reflector plate reflecting light, which is emitted from the cold cathode-ray tubes 42 to the light guide plate 36, toward the liquid crystal panel 33. The antistatic sheet 39 is transparent and adhered onto the back side of the rear holder 38 by two-sided adhesive tape and covers a back face of each opening 38A through 38D (refer to FIG. 3) which is formed on the rear holder 38.

In above mentioned configuration around the liquid crystal display 4, a couple of cold cathode-ray tubes 43 are disposed in order to light up symbols formed on each outer peripheral surface of the three reels 46, 46, 46, and the reel 46A. However, it may be arranged in the following configuration.

More specifically, in the configuration shown in FIGS. 2 and 3, a couple of cold cathode-ray tubes 43 are not disposed in order to light up symbols formed on each outer peripheral surface of the three reels 46, 46, 46 and reel 46A. Instead, a light emitted from the cold cathode-ray tubes 42 to the light guide panel 36 may partially be introduced to openings 36A, 36B, 36C and 36D such that light introduced to openings 36A, 36B, 36C and 36D is emitted from light scattering faces, which are made on the edge faces of the openings 36A, 36B, 36C and 36D. Therefore, outer peripheral surfaces of the respective three reels 46, 46, 46 and the reel 46A may be irradiated by the light emitted from the light scattering faces.

Further, in the configuration without the cold cathode-ray tubes 43 as described above, concave portions may be formed on the light guide plate 36 instead of openings 36A, 36B, 36C, 36D and light scattering faces may be made on these concave portions.

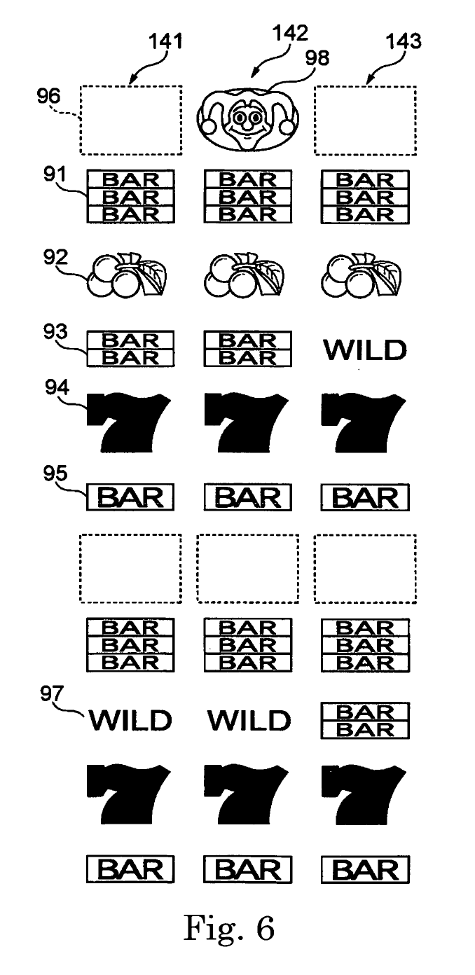

Various types of identification symbols as shown in FIG. 6 to be used in the game are formed on outer peripheral surfaces of the respective three reels 46, 46, 46. FIG. 6 shows arrays of symbols formed on the outer peripheral surfaces of the respective three reels 46, 46, 46 which are scrolled and displayed variably in the base game in the respective transparent variable display parts from 22 through 24 of the lower liquid crystal display 4. In FIG. 6, the symbol column 141 is displayed variably in the variable display part 22 and the symbol column 142 is displayed variably in the variable display part 23 and the symbol column 143 is displayed variably in the variable display part 24. As shown in FIG. 6, the symbol columns 141 and 143 comprise arrays of symbols and each symbol column is composed of a combination of eleven symbols that are combined selectively and redundantly from a triple BAR 91, a cherry 92, a double BAR 93, a seven 94, a single BAR 95, a blank (an area without symbol) 96, a WILD 97. The WILD 97 is an almighty symbol or a wild card, which can be any one of the triple BAR 91, the cherry 92, the double BAR 93, the seven 94 and the single BAR 95.

Further, the symbol column 142 is similar to the symbol columns 141 and 143 (as described above) in a point that the triple BAR 91, the cherry 92, the double BAR 93, the seven 94, the single BAR 95 and the blank (an area without symbol) 96 are included and combined, but a trigger symbol 98 is also formed in the symbol column 142. As described later, the trigger symbol 98 is a symbol to shift the game into a bonus game, and it is possible to shift the game into the bonus game when the trigger symbol 98 is stopped and displayed on the activated pay line L in the variable display part 23.

Although various kinds of identification symbols are generally formed on outer peripheral surfaces of the respective three reels 46, 46, 46 such that eleven symbols are printed on each long reel sheet with conformed width and peripheral length of each reel and the thus-printed long reel sheet is attached to a peripheral face of each reel 46. However, such identification symbols may, of course, be formed thereon in another way than this.

When the symbol columns 141 through 143 are scrolled and stopped to appear in the variable display parts 22 through 24, three identification symbols are stopped and displayed in each of the variable display parts 22 through 24. In addition, various kinds of winning combination are set in advance based on combinations of various identification symbols, and when a winning combination of identification symbols is stopped and displayed on the activated pay line L, coins are paid out from the coin payout opening 15 according to the winning combination. In this point, it is similar to a conventional slot machine, and therefore, an explanation thereof is omitted.

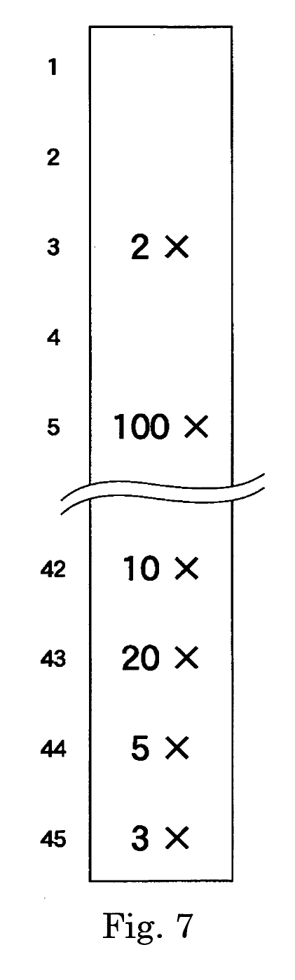

As shown in FIG. 7, various kinds of multiplication symbols used in the game are formed on an outer peripheral surface of the reel 46A. FIG. 7 is a diagram showing an array of multiplication symbols formed on the outer peripheral surface of the reel 46A which is scrolled and displayed variably in the transparent multiplication display part 25 of the lower liquid crystal display 4 during the game. The array of multiplication symbols is composed of a combination of forty-five multiplication symbols including double (twice), triple (three times), quintuple (five times), decuple (ten times), vigintuple (twenty times) and one hundred times. When the winning combination is stopped and displayed along any of the activated pay lines L, the amount to be paid out to the player is determined by multiplying the payout amount of the winning combination by a multiplication factor corresponding to the multiplication symbol displayed on an extension line from the any of the activated pay lines L of the winning combination. Here, the multiplication symbol corresponds or equates to the privilege symbol according to the present invention.

[2. Example of Control System of Slot Machine]

Next, an explanation will be made for the configuration of the control system of the slot machine 1 by referring to FIG. 4. FIG. 4 is a block diagram showing the control system in the slot machine schematically. As shown in FIG. 4, the control system of the slot machine 1 is basically set up with a microcomputer 103 as a core component, which is comprised of the CPU 100, a ROM 101 and a RAM 102 such that the ROM 101 and the RAM 102 are connected with the CPU 100. The ROM 101 stores various kinds of programs, data tables, and the like to conduct necessary processes for controlling the slot machine 1, for example, a main process, a start acceptance process, a lottery process, a base game process, a bonus game process, a free-spin process and the like to be described later. The RAM 102 is constituted as a temporary memory for storing various kinds of data calculated by the CPU 100 temporarily.

In addition, a clock pulse generating circuit 104 which generates a reference clock pulse and a frequency divider 105 are connected with the CPU 100. And further, a random number generator 106 which generates random numbers and a random number sampling circuit 107 are connected with the CPU 100. The random numbers sampled by the sampling circuit 107 are used for conducting of various kinds of lotteries such as determination of the winning combination. Further, the spin switch S1 attached to the spin (SPIN/REPEAT-BET) button 12, the 1-BET switch S2 attached to the 1-BET button 11, the 3-BET switch S3 attached to the 3-BET button 13, the 5-BET switch S4 attached to the 5-BET button 14, the change (CHANGE) switch S5 attached to the change button 6, the payback (CASHOUT) switch S6 attached to the payout button 7, the help (HELP) switch S7 attached to the help button 8 are connected respectively with the CPU 100. According to the switch signals which are outputted from respective switches upon depression of the buttons, the CPU 100 controls various executions of operations relating to the respective buttons.

Respective stepping motors 47, 47A to rotate the respective reels 46, 46A are connected with the CPU 100 through a motor driving circuit 45, and a reel position detection circuit 48 is also connected to the CPU 100. When the driving signal is outputted from the CPU 100 to the motor driving circuit 45, each stepping motor 47 is driven to rotate by the motor driving circuit 45. Thus, each reel 46 is rotated. When rotation of each reel 46 is started, a driving pulse number provided to each stepping motor 47 is calculated, and the calculated value is written in a predetermined area of the RAM 102. A reset pulse is outputted from each reel 46 for one rotation, and such reset pulse is inputted into the CPU 100 through the reel position detection circuit 48. Thus, when the reset pulse is inputted into the CPU 100, the calculated value written in the RAM 102 is cleared to “0” and the CPU 100 recognizes rotation positions of symbols on each reel 46 according to the calculated value corresponding to the rotation position within one rotation of each reel 46 and a symbol table listing symbols formed on the peripheral face of each reel 46 and respectively-corresponding rotation positions stored in the ROM 101.

In addition, the coin sensor S8 disposed in the coin insertion slot 9 and the bill sensor S9 disposed in the bill insertion slot 10 are connected with the CPU 100, respectively. The coin sensor S8 detects coins inserted from the coin insertion slot 9, and the CPU 100 calculates the number of inserted coins according to the coin detection signal outputted from the coin sensor S8. The bill sensor S9 detects the types and amount of bills inserted from the bill insertion slot 10, and the CPU 100 calculates the number of coins to be equivalent to the amount of bills according to the bill detection signal outputted from the bill sensor S9.

A hopper 50 is connected with the CPU 100 through a hopper driving circuit 49. When a driving signal is outputted from the CPU 100 to the hopper driving circuit 49, the hopper 50 pays out coins the predetermined number of coins from the coin payout opening 15. In addition, the coin detector 52 is connected with the CPU 100 through a payout completion signal circuit 51. The coin detector 52 is disposed inside of the coin payout opening 15. When the coin detector 52 detects that a predetermined number of coins are paid out from the coin payout opening 15, a coin payout detection signal is outputted from the coin detector 52 to the payout completion signal circuit 51 such that a payout completion signal is outputted from the payout completion signal circuit 51 to the CPU 100. Further, the upper liquid crystal display 3 and the lower liquid crystal display 4 are connected with the CPU 100 through a liquid crystal driving circuit 53 such that the upper liquid crystal display 3 and the lower liquid crystal display 4 are controlled by the CPU 100.

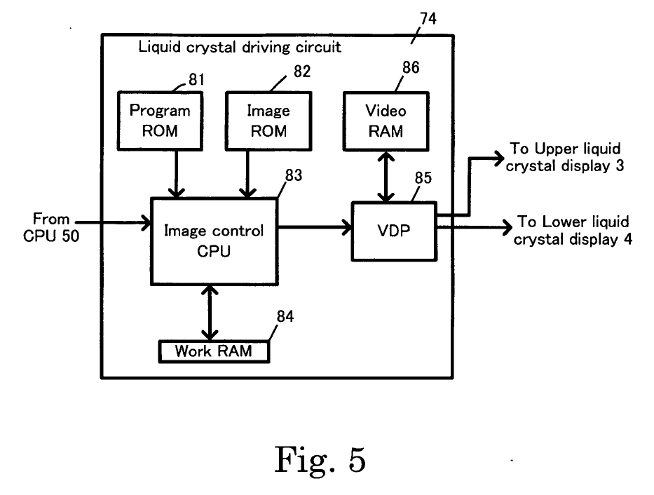

As shown in FIG. 5, in this point, the liquid crystal driving circuit 53 is composed of a program ROM 81, an image ROM 82, an image control CPU 83, a work RAM 84, a VDP (video display processor) 85, a video RAM 86 and so on. And the program ROM 81 stores image control program and various kinds of selection tables relating to displays at the upper liquid crystal display 3 and the lower liquid crystal display 4. Also, the image ROM 82 stores dot data to form images, for example, dot data for forming images on the upper liquid crystal display 3 or the lower liquid crystal display 4. Also, on the basis of parameters set by the CPU 100, the image control CPU 83 determines the images to be displayed on the upper liquid crystal display 3 or the lower liquid crystal display 4 by using dot data stored in the image ROM 82 in accordance with the image control program which is previously stored in the program ROM 81. The work RAM 84 is constituted as a temporary storage mean when the image control CPU 83 executes the image control program. Also, the VDP 85 generates image data corresponding to the display contents determined by the image control CPU 83, and outputs the data to the upper liquid crystal display 3 or the lower liquid crystal display 4. Here, the video RAM 86 is constituted as a temporary storage mean for forming images by the VDP 85.

In addition, a number of LEDs (light emitting diodes) 57 is connected with the CPU 100 through a LED driving circuit 57. When various kinds of effects are performed by the number of LEDs 57 disposed on the front face of the slot machine 1, the LED driving circuit 56 conducts a lighting control of the LEDs 57 according to the driving signal from the CPU 100. Further, a sound output circuit 58 and a speaker 59 are connected with the CPU 100, and when various kinds of effects are conducted according to the outputted signal from the sound output circuit 58, the speaker 59 generates respective kinds of effect sounds.

In addition, the lamp 21 is connected with the CPU 100 through a lamp driving circuit (not shown). The lamp 21 is disposed on the top face of the slot machine 1 (refer to FIG. 1), when the change button 6 is depressed, a lamp driving circuit 56 conducts a lighting control of the lamp 21 according to the driving signal from the CPU 100.

Also, the transparent touch panel 30 is connected with the CPU 100 through a touch panel driving circuit 54. The transparent touch panel 30 is provided on the screen of the lower liquid crystal display 4 so as to output coordinate information about the place where the player touches through the touch panel driving circuit 54 such that the CPU 100 can determine the position where the player touches.

When the base game and the bonus game are conducted in the slot machine 1, the CPU 100 determines the identification symbols to be stopped and displayed on the activated pay line L by lottery. The CPU 100 conducts each stop control of the left reel 46, the center reel 46 and the right reel 46 such that the identification symbols determined by lottery are stopped and displayed along the activated pay line L. The identification symbols disposed on each of the three reels 46, 46, 46 are to be visually recognized through three variable display parts 22 through 24. Hereafter, the identification symbols which are recognized in a stationary manner after the variable display through the three variable display parts 22 through 24 by the player may be called “stopped identification symbols”.

Symbol columns are provided on respective outer peripheral surfaces of the three reels, i.e., the left, center and right reels 46, 46, 46. FIG. 6 shows an example of symbol columns 141, 142, 143 which are formed on outer peripheral surfaces of the left, center and right reels 46, 46, 46.

The symbol columns 141, 142, 143 are composed of eleven identification symbols, respectively. The identification symbols include eight kinds of symbols: “3 BAR” symbol 91, “cherry” symbol 92, “2 BAR” symbol 93, “7” symbol 94, “BAR” symbol 95, “blank (space)” symbol 96, “WILD” symbol 97 and a bonus symbol 98 as a bonus game trigger to the bonus game.

The lottery for the stopped identification symbols is conducted according to a random number sampled by the CPU 100 through the sampling circuit 107. On the other hand, a lottery table is in advance provided, in which a relationship between random numbers and combinations of the stopped identification symbols is listed. Thus, the CPU 100 determines the stopped identification symbols by referring to this lottery table with the sampled random number.

In this embodiment, the stopped identification symbols on the respective three (left, center and right) reels 46 are determined at the same time by one random number. However, the determination may be made in a way that the stopped identification symbols may be separately determined for the respective three (left, center and right) reels 46 with the respective random numbers sampled respectively.

Also, when the base game or the bonus game is conducted in the slot machine 1, the CPU 100 determines the multiplication symbols to be stopped and displayed in the multiplication display part 25 by a lottery. The CPU 100 conducts the stop control of the reel 46A so as to stop and display multiplication symbols determined by the lottery in the multiplication display part 25. The multiplication symbols disposed on the reel 46A are to be visually recognized through the multiplication display part 25 by the player. Hereafter, the multiplication symbols stopped and recognized through the variable display part 25 by the player after the variable display may be called “stopped multiplication symbols”.

The lottery for the stopped multiplication symbols is conducted according to a random number sampled by the CPU 100 through the sampling circuit 107. The lottery table is in advance provided, in which a corresponding relationship between random numbers and the stopped multiplication symbols is listed, such that the CPU 100 determines the stopped multiplication symbols by referring to the lottery table with the sampled random number.

Next, an explanation will be made for the winning combination and a payout amount thereof in the case of conducting the base game by utilizing the three display parts 22 through 24 and the multiplication display part 25 in the slot machine 1.

In this embodiment, the lottery by random number extraction determines whether the winning combination is won or not, and which winning combination is won in the case of the winning combination. The CPU 100 determines whether to conduct the payout or not and determines the payout number of coins to be paid out in the case of the payout, in other words, determines the payout amount based on the random number for determination of the stopped symbols by utilizing the winning combination and payout table having been provided in advance.

[3. Example of Function of Control System in Slot Machine]

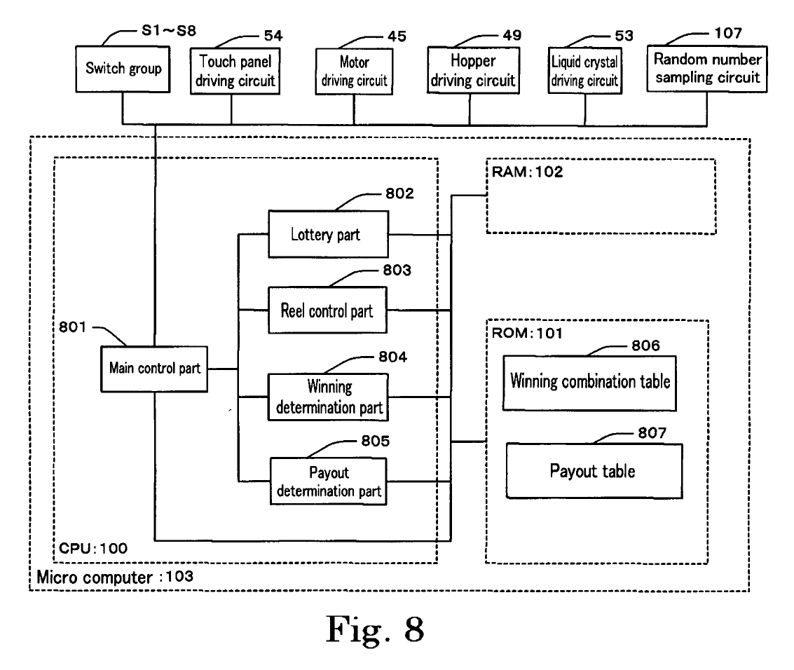

The function of the slot machine 1 according to this embodiment is realized mainly through execution of the program stored in the ROM 101 by the microcomputer 103, more specifically, the CPU 100. Hereafter, an explanation will be made for the function which is realized through the execution of the program by the microcomputer 103, more specifically, by the CPU 100. FIG. 8 is a functional block diagram showing a control system in the slot machine 1. An example shown in the figure, the CPU 100 works as a main control part 801, a lottery part 802 called and run by the main control part 801, a reel control part 803, a winning combination determination part 804 and a payout determination part 805.

[3.1. Main Control Part]

A Main control part 81 conducts an overall control of the operation of each circuit and each part in the slot machine 1. In particular, the main control part 801 receives respective input signals from the coin sensor S8, the spin switch S1, the 1-BET switch S2, the 3-BET switch S3, the 5-BET switch S4, the change (CHANGE) switch S5, the payout (CASHOUT) switch S6, the help (HELP) switch S7, the coin sensor S8, the bill sensor S9 (here, switches S1 through S9 are generally referred to as “switch group”), and the touch panel driving circuit 54, and initiates each part based on the received input signals so as to command the respective parts to conduct processes according to the input signals.

Further, the main control part 801 obtains the random number from the random number sampling circuit 107 based on a demand from the lottery part 802, and sends the random number to the lottery part 802. In addition, the main control part 801 sends an image generation command to the liquid crystal driving circuit 53 in order to make the upper liquid crystal display 3 and/or the lower liquid crystal display 4 display images corresponding to the operations of the respective parts.

Also, the main control part 801 sends a coin payout command to the hopper driving circuit 49 and the payout of coins is conducted under predetermined conditions, for example, in the case that the player presses the payout (CASHOUT) button. Further, the main control part 801 sends driving commands to the LED driving circuit 56 and the sound output circuit 58 such that an effect is performed based on an operation of each part, and makes the LED 57 and the speaker 59 perform the effect.

[3.2. Lottery Part, Reel Control Part, Winning Combination Determination Part, Payout Determination Part]

Functions of the lottery part 802, the reel control part 803, the winning combination determination part 804, and the payout determination part 805, which are controlled by the main control part 801, will be described as follows.

The lottery part 802 has a function to determine the random number in order to determine the stopped identification symbols and the stopped multiplication symbols as the game is started.

The reel control part 803 has a function to control the movement and the halt of the movement of the respective reels 46, 46A in such a way that the stopped identification symbols and the stopped multiplication symbols determined by the lottery part 802 are to be stopped and displayed in the variable display parts 22, 23, 24 and the multiplication display part 25, respectively.

The winning combination determination part 804 has a function to determine whether the predetermined combination of symbols is formed or not along the pay line according to the stopped identification symbols on the respective reels 46 which are stopped based on the random number determined by the lottery part 802 or stopped by the reel control part 802. Here, the winning combination determination part 804 corresponds or equates to a winning combination determination mean according to the present invention.

The payout determination part 805 has a function to determine the value of the payout amount to be paid out to the player based on the stopped multiplication symbol which is displayed in the multiplication display part 25 along a corresponding position to the activated pay line on which the winning combination is formed. In this embodiment, the value of the payout amount is determined by multiplying the payout of the winning combination by a multiplication factor indicated by the stopped multiplication symbol that is displayed on an extension line from the activated pay line.

The payout determination part 805 calculates the value of the payout amount and sends the resulting value to the main control part 801. Then, the main control part 801 drives the hopper driving circuit 49 according to the value, or updates the credit value stored in the RAM 102. Here, the payout determination part 805 corresponds or equates to the payout determination mean according to the present invention.

[4. Example of Operation of Slot Machine]

Next, an explanation will be made for an example of the operation of slot machine 1 which is provided with the configuration described above.

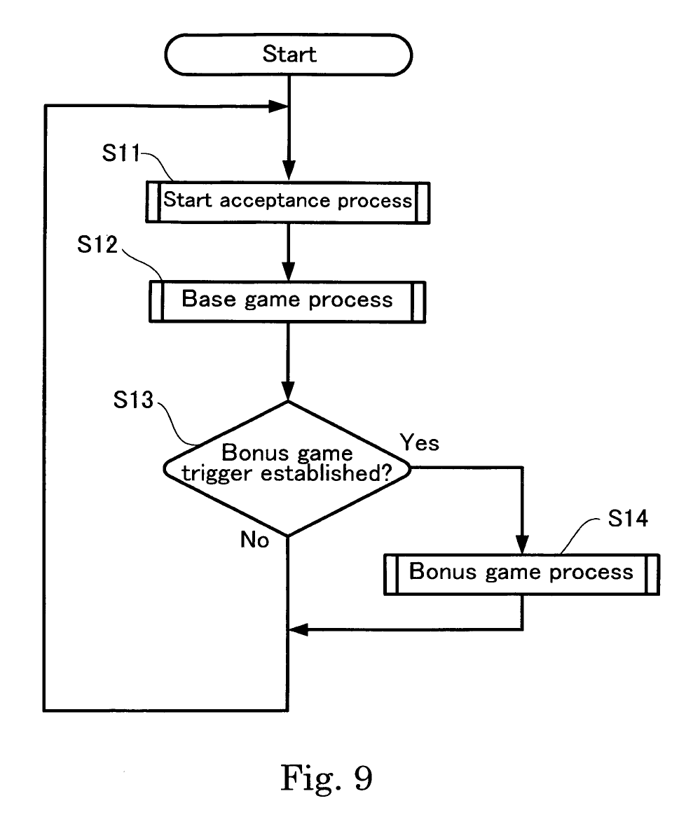

Firstly, a description will be made for an example of the main process conducted in the slot machine 1 in reference to FIG. 9. FIG. 9 is a flow chart showing an example of the main process. The slot machine 1 (in particular, the CPU 100) conducts the start acceptance process (S11). This process is a process for accepting a switch signal outputted from the spin switch S1, the 1-BET switch S2, the 3-BET switch S3 or the 5-BET switch S4 based on the operation of the spin (SPIN/REPEAT-BET) button 12, the 1-BET button 11, the 3-BET button 13 or the 5-BET button 14, respectively. The game is started when the switch signal outputted from each switch is accepted.

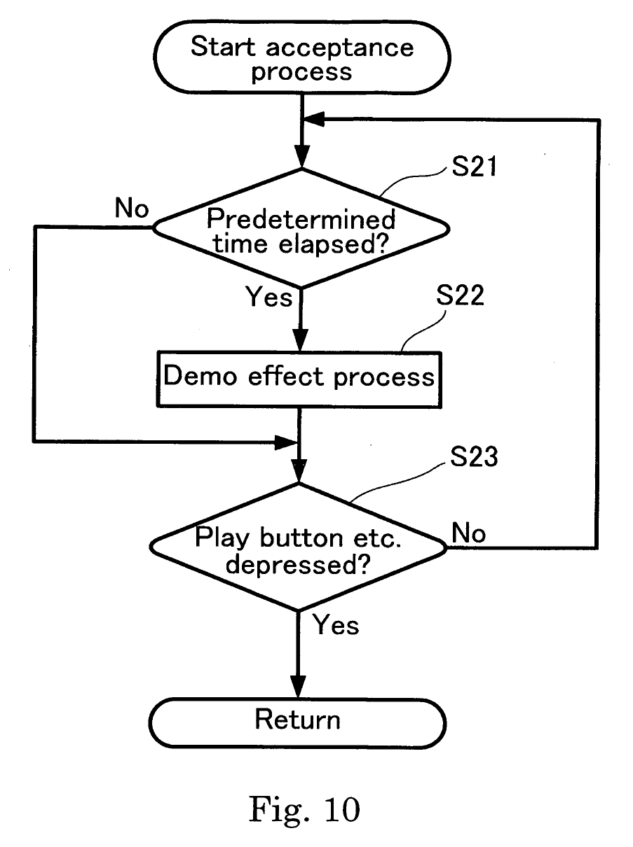

An explanation will be made for the start acceptance process conducted in the slot machine 1 in reference to FIG. 10. FIG. 10 is a flow chart which shows the start acceptance process. In the step of S11 of the main process as described in FIG. 9, the CPU 100 (or the main control part 801) determines whether a predetermined period of time (for example, 15 seconds) has elapsed or not (S21). In this instance, when the CPU 100 determines that the predetermined period of time has not elapsed (S21: No), the program proceeds to the step of S23 without any operations. However, when the CPU 100 determines that the predetermined period of time has elapsed (S21: Yes), the CPU 100 conducts a demonstration effect on the upper liquid crystal display 3 or the lower liquid crystal display 4 and then the program proceeds to the step of S23. Here, when the CPU 100 determines that the operation of the button such as the 1-BET button 11 has not been conducted (S23: No), the program returns to the step of S21 and repeats the processes described above, on the other hand, when the CPU 100 determines that the operation of the button such as the 1-BET button 11 has been conducted (S23: Yes), the program returns to the main process as described in FIG. 9 and proceeds to the base game process (S12) even though it is in the middle of the demonstration effect described above.

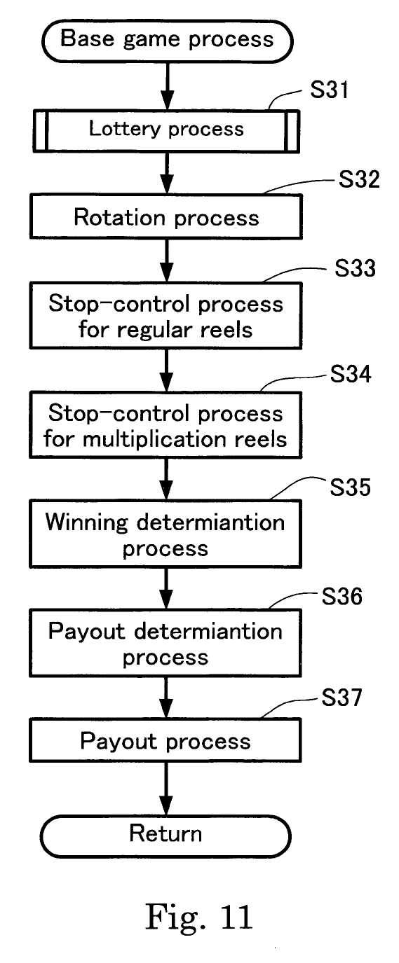

Next, an explanation will be made for the base game process (S12) conducted in the slot machine 1 in reference to FIG. 11. FIG. 11 is a flow chart which shows the base game process.

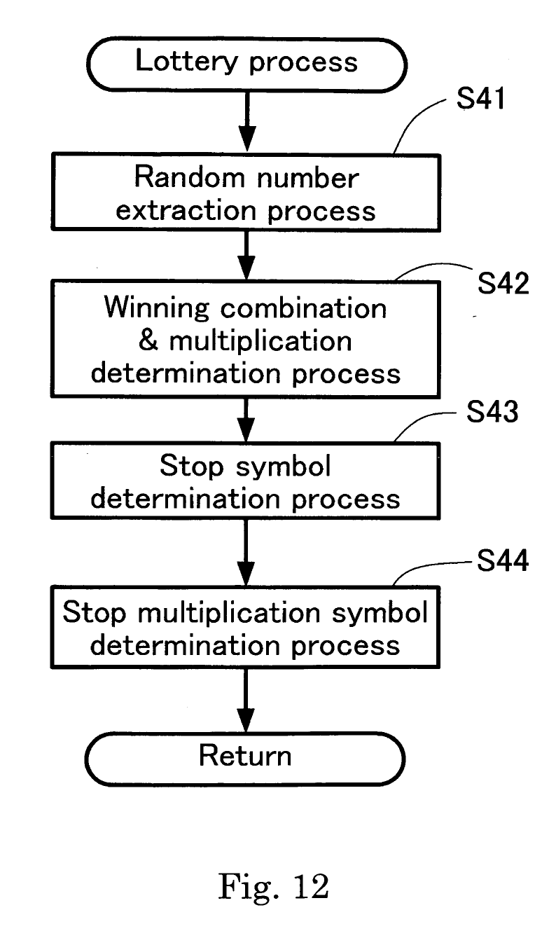

When the base game process is started, the CPU 100 (or the lottery part 802) conducts the lottery process (S31). An explanation will be made for the content of the lottery process (S31) in reference to FIG. 12. FIG. 12 is a flow chart which shows the lottery process.

The CPU 100 (or the lottery part 802) first conducts a random number extraction process (S41). The random number extraction process (S41) is a sampling process that the CPU 100 samples one random number through the random number sampling circuit 107.

The CPU 100 conducts a winning combination and multiplication determination process (S42) subsequent to the random number extraction process (S41). The winning combination determination process is a process for determining the winning combination corresponding to the extracted random number by comparing the random number having been extracted in the step of S41 with the winning combination table describing the relationship between the winning combinations (including the losing combination) and the random numbers, which is prepared in advance, and determining the stopped multiplication symbol. The winning combination table is a table in which the random numbers and the winning combinations are listed, for example, the “bonus game” for the extracted random number of any one from 1 to 10, the “three sevens” for the extracted random number of any one from 11 to 40, and the “losing combination” for the extracted random number of any one from 341 to 1024.

The CPU 100 (or the reel control part 803) conducts a stop identification symbol determination process (S43) subsequent to the winning combination and multiplication determination process (S42). The stop identification symbol determination process (S43) is a process for determining identification symbols to be stopped and displayed along the activated pay line L in each of the variable display parts 22 through 24 so as to obtain the winning combination determined in the winning combination and multiplication determination process. Specifically, the CPU 100 (or the reel control part 803) determines each code number for each identification symbol to be displayed on each reel 46 so as to form the winning combination to be stopped and displayed along the activated pay line L.

The CPU 100 (or the reel control part 803) conducts a stop multiplication symbol determination process (S44) subsequent to the stop identification symbol determination process (S43). The stop display multiplication symbol determination process (S44) is a process for determining the multiplication symbol to be stopped and displayed on a position corresponding to the activated pay line L so as to provide the multiplication factor having been determined in the winning combination and multiplication determination process to the player. Specifically, the CPU 100 (or the reel control part 803) determines the code number of the stopped multiplication symbol on the reel 46A such that the multiplication symbol corresponding to the determined multiplication factor is to be stopped and displayed on the position corresponding to the activated pay line L.

After completion of the stop multiplication symbol determination process (S44), the program returns to the base game process shown in FIG. 11 and proceeds to a rotation process in the step of S32.

First, the CPU 100 (or the reel control part 803) conducts the rotation process (S32) which starts rotations of the three reels 46 and the reel 46A inside of the cabinet 2 based on the switch signal having been outputted from the spin switch S1, the 1-BET switch S2, the 3-BET switch S3 or the 5-BET switch S4, which is accepted in the start acceptance process (S11). By the rotation process, the respective identification symbols are scrolled in the variable display parts 22 through 24 while the multiplication symbols are scrolled in the multiplication display part 25. In this case, as the variable display parts 22 through 24 and the multiplication display part 25 are in a transparent condition, the scroll of each symbol is recognized by sight.

Next, the CPU 100 (or the reel control part 803) conducts a regular reel stop control process (S33) for stopping rotations of the respective three reels 46 disposed inside of the cabinet 2 in such a way that the stopped identification symbols as determined in the stop identification symbol determination process (S43) are to be stopped and displayed along the activated pay line L. In the regular reel stop control process, the scrolls of the respective identification symbols are stopped in the variable display parts 22 through 24.

Subsequently, the CPU 100 (or the reel control part 803) conducts a multiplication reel stop control process (S34) for stopping the rotation of the reel 46A inside of the cabinet 2 in such a way that the stopped multiplication symbol as determined in the stop multiplication symbol determination process (44) is to be stopped and displayed on a position corresponding to the activated pay line L. In the multiplication reel stop control process, the scroll of the multiplication symbols is stopped in the variable display part 25.

Next, the CPU 100 (or the winning combination determination part 804) conducts a winning combination determination process (S35) for determining whether the winning combination is formed or not along the activated pay line L in reference to the stopped identification symbols which are stopped and displayed in the respective variable display parts 22 through 24 in the regular reel stop control process (S33).

Subsequently, the CPU 100 (or the payout determination part 805) conducts a payout determination process (S36) for obtaining the payout according to the winning combination determined in the winning combination determination process (S35) and the payout table 807 and for calculating the value of the payout amount by multiplying the payout by the multiplication factor obtained based on the stopped multiplication symbol having been stopped in the multiplication display part 25 in the multiplication reel stoop process (S34).

Next, the CPU 100 (or the main control part 801) conducts a payout process (S37) for paying out the number of coins or for adding the number of credits which are equivalent to the value of the payout amount calculated in the payout determination process (S36).

After the payout process, the base game process is completed and it returns to the main process program as shown in FIG. 9.

By referring back to FIG. 9, the explanation of the main process is resumed.

After the base game process (S12), the CPU 100 (or the main control part 801) determines whether the bonus game is established or not (S13). The determination is conducted based on symbols stopped along the activated pay line L in the regular reel stop control process (S33), or the random number or the winning combination determined in the lottery process (S31).

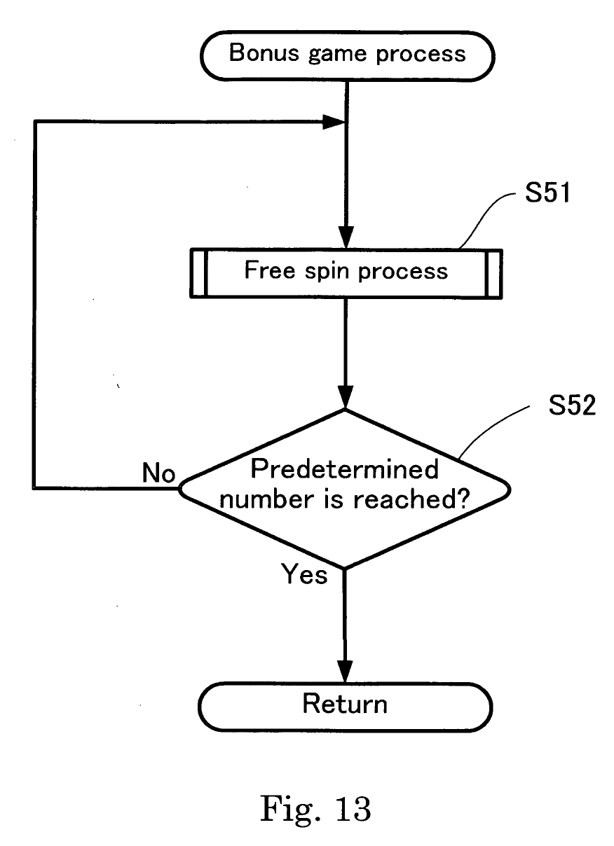

When the CPU 100 (or the main control part 801) determines that the bonus game is won (S13: Yes), the CPU 100 conducts the bonus game process (S14). FIG. 13 is a flow chart which shows an example of the bonus game process.

Upon starting the bonus game process (S14), the slot machine 1 conducts a predetermined number of free-spins (assuming ten (10) times in this embodiment). Thus, the bonus game is equivalent to the execution of ten free-spins in this embodiment.

During the execution of each free-spin, similar processes to the base game process are conducted without inserting coins or pressing the BET button, in other words, the player can play the game without consuming his/her coins or credits having been accumulated. Thus, the player has a great advantage in obtaining coins or credits to be paid out during the bonus game since he/she can receives the payout of coins or credits without consuming his/her coins or credits.

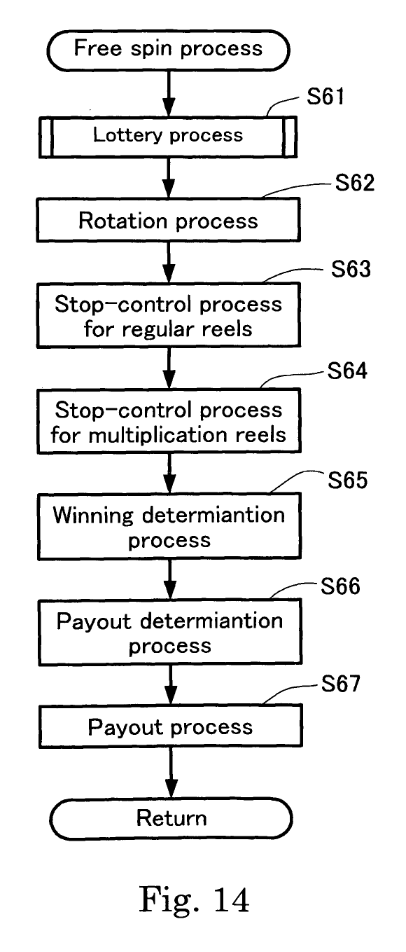

FIG. 14 shows an example of the free-spin process (S51) according to the present embodiment. Hereafter, an example of the free-spin process will be explained in reference to FIG. 14.

When the free-spin process is started, the CPU 100 conducts the lottery process (S61), the rotation process (S62), the regular reel stop control process (S63), the multiplication reel stop control process (S64), the winning combination determination process (S65), the payout determination process (S66) and the payout process (S67) according to the predetermined operation by the player. Since the contents of these processes S61 through S67 are similar to the lottery process (S31), the rotation process (S32), the regular reel stop control process (S33), the multiplication reel stop control process (S34), the winning combination determination process (S35), the payout determination process (S36), the payout process (S37) as described in the base game process, the explanation of each process will be omitted. However, as described above, it is not necessary to insert coins or press the BET button for starting the variable display of symbols in the free-spin process. Thus, the player is given a chance to gain coins without consuming his/her accumulated coins or credits.

As the above-mentioned processes S61 through S67 are conducted, one process of the free-spin is completed. Then, the explanation of the free-spin process (S61 through S67) is completed, and it returns to the explanation of the bonus game (FIG. 13).

By referring back to FIG. 13, the explanation of the bonus game will be resumed.

In the bonus game process (FIG. 13), when the free-spin process (S51) is completed, the CPU 100 (or the main control part 801) determines whether the predetermined number of free-spins have been conducted or not (S52), which is a condition to complete the bonus game. When it determines that the predetermined number of free-spins have not been conducted (S52: No), the CPU 100 (or the main control part 801) conducts another free-spin process (S51). On the other hand, when it determines that the predetermined number of free-spins have been conducted (S52: Yes), the CPU 100 (or the main control part 801) terminates the bonus game process, and the program returns to the main process (FIG. 9). Thus, the explanation of the bonus game process (S14) is completed.

By referring back to FIG. 9, the explanation of the main process is continued.

In the step of S13, when the bonus game is not established (S13: No) or the bonus game process (S14) is completed, the CPU 100 (or the main control part 801) returns the program to the start acceptance process (S11) again, and prepares for the next start of game.

Thus, the explanation of the main process and the example of the operation in the slot machine are completed.

[5. Example of Display]

An example of the content displayed on the lower liquid crystal display 4 is explained as an example of the operation of the slot machine 1 in this embodiment.

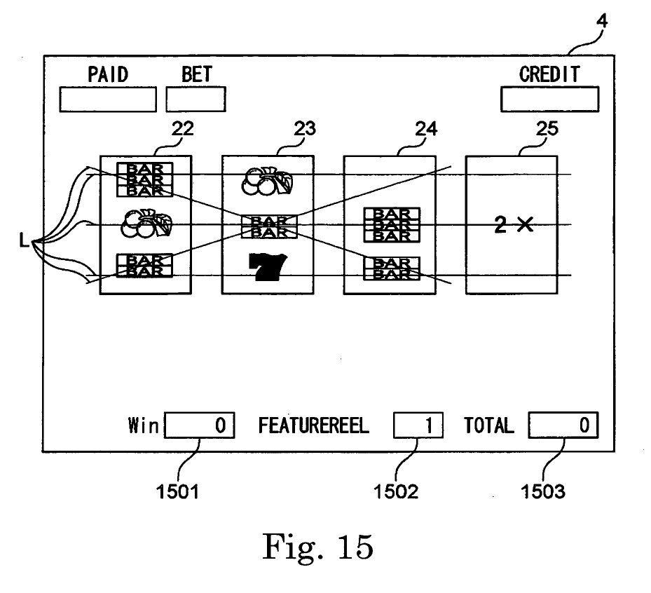

FIG. 15 is a figure which shows the lower liquid crystal display 4 in a condition before initiation of the game. The variable display parts 22, 23, 24, and the multiplication display part 25 are provided in the lower liquid crystal display 4. In each of the variable display parts 22, 23, 24, the stopped identification symbols can be seen as the result of the previous game while the stopped multiplication symbols can be seen at the multiplication display part 25 as the result of the previous game.

In the bottom part of the lower liquid crystal display, a payout display area 1501 for showing the payout of the winning combination, a multiplication display area 1502 for displaying the multiplication factor corresponding to the multiplication symbol disposed on a position corresponding to the activated pay line when the winning combination is made along the activated pay line, and a pay out display area 1503 for displaying the value of the payout amount having been paid out to the player, which is a product of the value displayed in the payout display area 1501 and the value displayed in the multiplication display area 1502. These areas 1501 through 1053 have images displayed by the liquid crystal display 4.

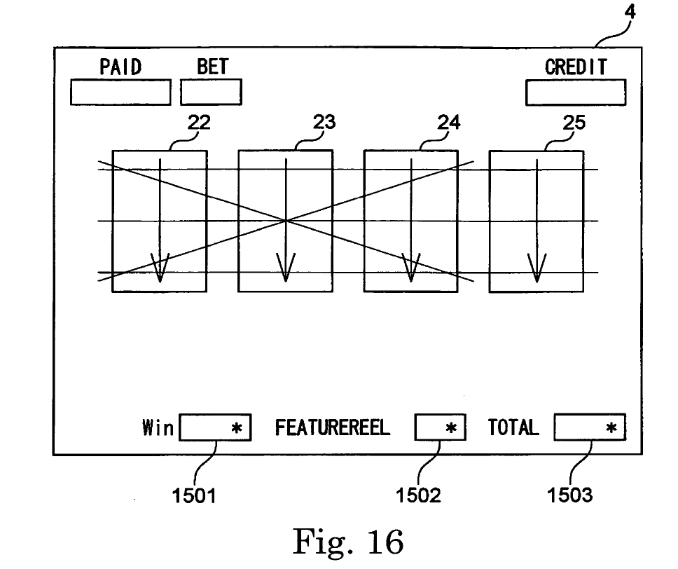

FIG. 16 is a figure showing the state of the lower liquid crystal display 4 when the game is started and the rotation process (S32) is being conducted. In this state, the variable displays of the identification symbols are conducted in the respective variable display parts 22, 23, 24 while the variable display of the multiplication symbols is conducted in the multiplication display part 25. Down arrows shown in the figure indicate that the variable displays are being conducted.

As values to be displayed in the payout display area 1501, the multiplication display area 1502 and the payout display area 1503 are not determined yet, “* symbols indicating to be determined later are displayed in each of the areas 1501 through 1503 in this example.

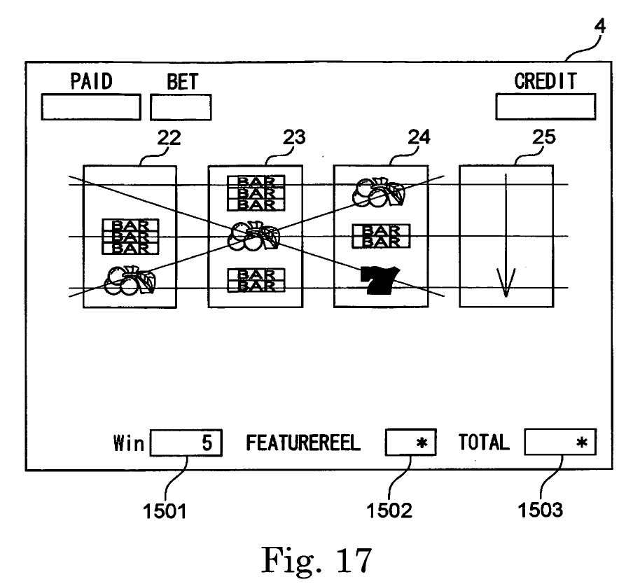

FIG. 17 is a figure showing the state of the lower liquid crystal display 4 when the regular reel stop control process (S33) is conducted after completion of the rotation process (S32) as shown in FIG. 16.

In this state, the stopped identification symbols are displayed in the variable display parts 22, 23, 24, and the winning combination of “cherry,” “cherry” and “cherry” is established along a cross-up line (positive slope line) which is one of the activated pay lines L. The number of “5” indicating the payout of the winning combination of cherry is displayed in the payout display area 1501.

On the other hand, as the variable display is being conducted in the multiplication display part 25, respective numbers to be displayed in the multiplication display area 1502 and the payout display area 1503 are still not determined, and therefore the “*” symbols are displayed in the respective areas 1502 and 1503.

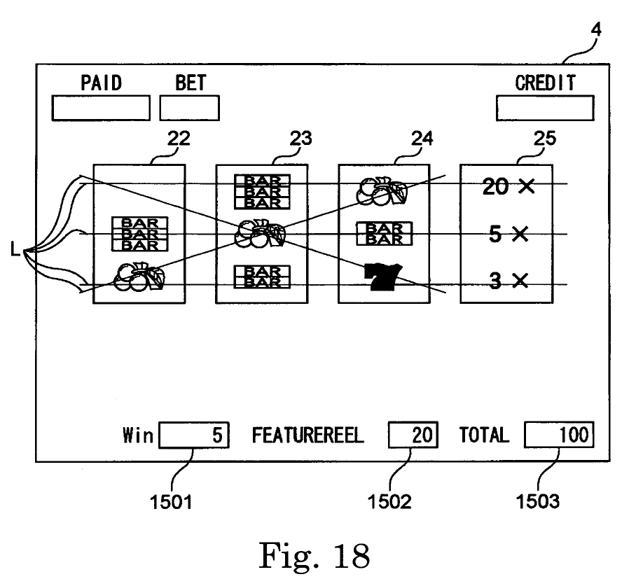

FIG. 18 is a drawing which shows the state of the lower liquid crystal display 4 when the magnification ratio reel stop control process (S34) is conducted after completion of the usual reel stop control process (S33) shown in FIG. 17. In this state, the stopped display identification symbols are displayed in the variable display parts 22, 23, 24, while the stopped display multiplication symbols are also displayed in the multiplication display part 25. In this example, the multiplication symbol “20×” indicating twenty times, the multiplication symbol “5×” indicating five times, the multiplication symbol “3×” indicating three times appear as the stopped display multiplication symbols in the multiplication display part 25.

The activated winning combination line L on which the winning combination of “cherry” is formed is the cross-up line (positive slope line) and the multiplication symbol displayed on the position corresponding to the cross-up line is the “20×” multiplication symbol indicating 20 times. Therefore, the multiplication factor of “20” is displayed on the position corresponding to the activated pay line (the cross-up line) in the multiplication display area 1502. In addition, in the payout display area 1503, the value “100” which is a product of the value of “5” displayed in the payout display area 1501 and the value of “20” displayed in the multiplication display area 1502.

The slot machine 1 is to pay out the number of coins or credits which are equivalent to the value of “100” displayed in the payable payout display area 1503 to the player.

As described above, in the slot machine 1 according to this embodiment, the variable display and the stop display of multiplication symbols are conducted as well as the variable display and the stop display of identification symbols such that it may be expected a large amount of payout to be paid out even for a small payout rate of the winning combination of the stopped identification symbols because the multiplication factor is multiplied to the small payout rate to yield the large amount of payout. Therefore, even though the symbols having been stopped first does not include any winning combinations having high payout rates, it is possible to keep the player's expectation until the last reel stops so as to enhance the player's desire to play the game.

[6. Example of Modification]

An explanation will be made for an example of a modification of the slot machine 1 of this embodiment having been described above.

It is OK to modify the above-mentioned slot machine 1 so as to implement the following features.

The “WILD” symbol 97 is included in the identification symbols provided to the above-mentioned slot machine 1. In the slot machine 1 of the present modified example, when the “WILD” symbol 97 is included in the stopped identification symbols, an effect display to stretch or expand the “WILD” symbol 97 is performed as well as it is assumed that the “WILD” symbol 97 applies to the all or a part in the variable display area such that the winning combination determination is conducted with this assumption.

The effect display of stretching or expanding the “WILD” symbol 97 is realized in such a way that a motion picture showing the stretch or expansion of the ” WILD” symbol 97 is performed in the variable display area in the lower liquid crystal display 4.

According to this modification example, it is possible to increase the probability to win (probability that the winning combinations are formed) by use of spread or enlarged display of the “WILD” symbol 97 and provide the player with an incentive to play the game and also attract his/her interest by fresh effect displays which are unable to be displayed by the conventional gaming machine having only mechanical reels.

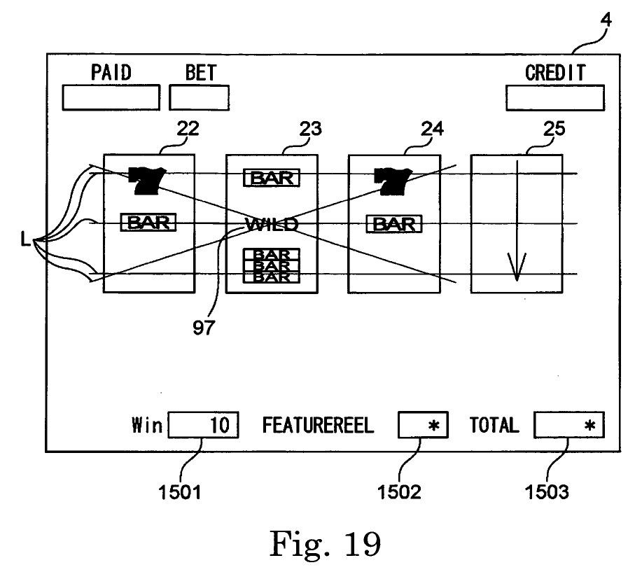

FIGS. 19 through 22 are drawings showing examples of the contents displayed in the lower liquid crystal display 4 of the slot machine 1 according to this modified example.

FIG. 19 is a drawing which shows an example of the content being displayed in the lower liquid crystal display 4 when the regular reel stop control process (S33) is conducted after completion of the rotation process (S32). In this example, the stopped identification symbols are displayed in the variable display parts 22, 23, 24, respectively, and the “WILD” symbol 97 is stopping at the center of the variable display part 23. The “WILD” symbol 97 may be regarded as the “BAR” symbol 95 such that the winning combination of “BAR” is established on the center line among the activated pay lines L. Therefore, the value of “10” which is equivalent to the payout rate of the winning combination of “BAR” is displayed in the payout display area 1501

The variable display is being conducted in the multiplication display part 25, so that each value to be displayed in the multiplication display area 1502 and the payout display area 1503 is still not determined, and therefore, the symbols of “*” are displayed in the areas 1502, 1503.

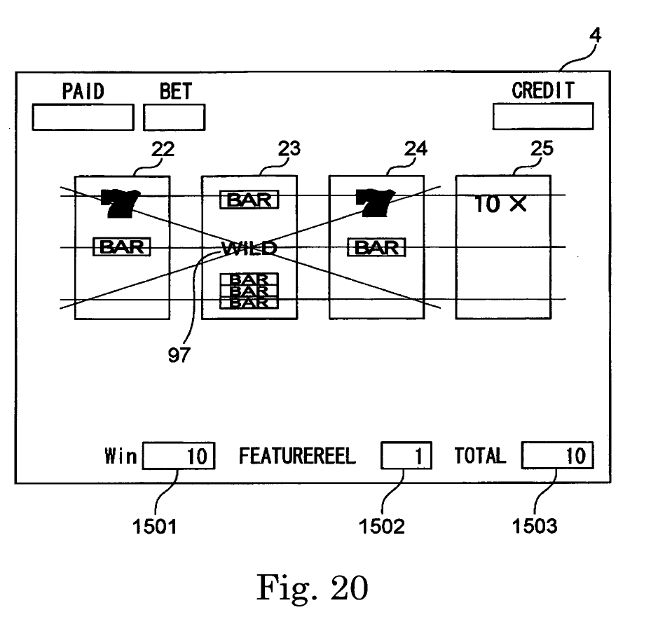

FIG. 20 is a drawing which shows an example of the content which is displayed on the lower liquid crystal display 4 when the multiplication reel stop control process (S34) is conducted after completion of the regular reel stop control process (S33). In this example, the multiplication symbol of “10×” which indicates ten times appears as the stopped multiplication symbol in the upper section on the multiplication display part 25 while the two multiplication symbols of “blank” indicating single time appear as the stopped multiplication symbols in the middle and bottom sections of the multiplication display part 25, respectively.

Therefore, the multiplication factor of “1” corresponding to the middle line is displayed in the payout display area 1502. In addition, the value of “10” which is the result of calculation of multiplying “10” (which is the value shown in the payout display area 1501) by “1” (which is the value shown in the magnification ratio display area 1502) is displayed in the payout display area 1503.

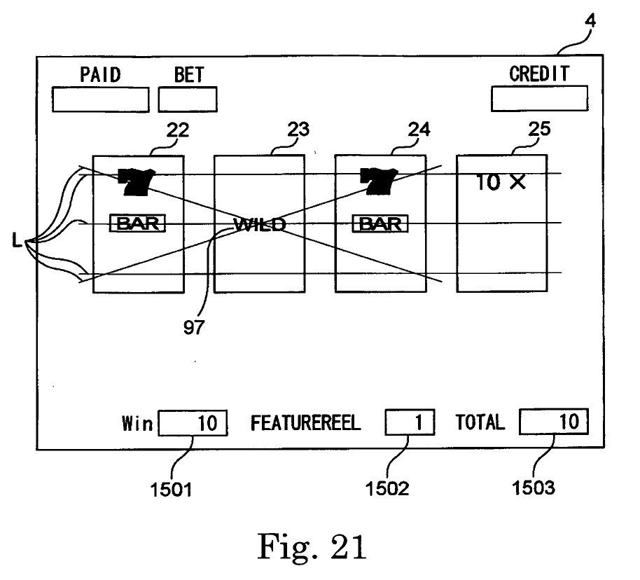

FIG. 21 is a drawing which shows an example of the content displayed on the lower liquid crystal display 4 which is in the state that the effect display of stretching or expanding the “WILD” symbol 97 is just begun after the state of FIG. 20. The lower liquid crystal display 4 makes opaque an area equivalent to the variable display part 23 where the symbol of “WILD” 97 is displayed and displays an image of the symbol of “WILD” 97. Therefore, the symbols on the reels 46 at least in the variable display area 23 become invisible from the player.

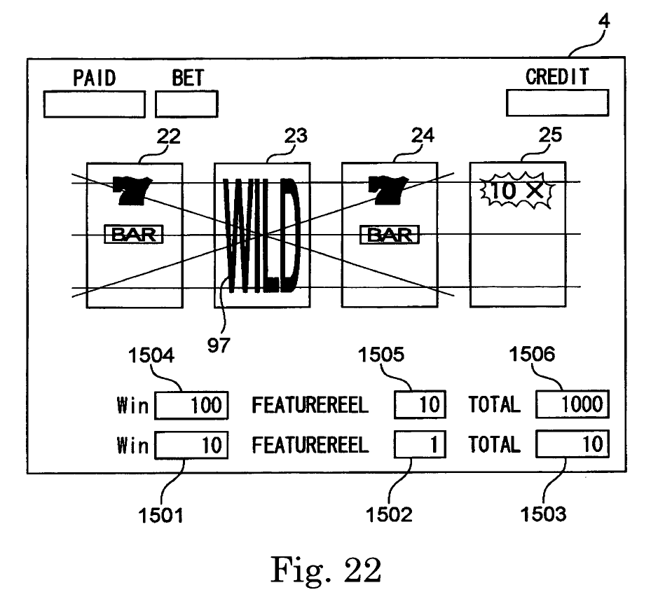

FIG. 22 is a drawing which shows an example of the content displayed on the lower liquid crystal display 4 which is in the state that the effect display of stretching or expanding the symbol of “WILD” 97 is completed after the state of FIG. 21. In this example, a motion picture image of the symbol of “WILD” 97 displayed on the lower liquid crystal display 4 is gradually expanding to cover all the sections (upper, middle and lower sections) in the variable display part 23.

The winning combination determination part 804 reattempts the winning combination determination along with the effect display. In other words, the expanded “WILD” symbol 97 replaces the stopped display identification symbols which are to be located in the sections covered by the expanded “WILD” symbol 97 (in this example, the upper and lower sections of the variable display part 23) in the winning combination determination process. Thus, the “7” combination as one of the winning combinations is to be formed along the top line of the activated pay lines L in this example.

The winning combination of “7” is won in addition to the winning combination of “BAR”, therefore, a new payout display area 1504, a new multiplication display area 1505 and a new payout display area 1506 are displayed additionally above the old display areas 1501, 1502 and 1503 on the lower part of the liquid crystal display 4. The payout rate of “100” corresponding to the winning combination of “7” is displayed in the payout display area 1504. The multiplication factor of “10” is displayed on a position corresponding to the top line of the activated pay lines L in the multiplication display area 1505 in the case where the winning combination of “7” is established. In addition, the value of “1000” which is a product of “100” (shown in the payout display area 1504) and “10” (shown in the multiplication display area 1505) is displayed in the payout display area 1506.

As a result, the total of payout amounts to be paid out to the player after the state of FIG. 22 is “1010” which is given by adding “10” (a product of the payout rate of the winning combination of “BAR” and the multiplication factor) and “1000” (a product of the payout rate for the winning combination of “7” and the multiplication factor).

[7. Others]

However, the present invention is not limited to the above-described embodiments and it should be understood that various changes and modifications may be made without departing from the scope of the present invention. Further examples of modifications of the present invention are shown as follows.

The multiplication display part 25 may be provided in any place if the player can recognize the relation between the multiplication display part 25 and the activated pay lines. For example, the multiplication display 25 may be provided on the right side of the variable display part 22 (on the left side if facing the slot machine); or provided between the variable display parts 22 and 23; or between the variable display parts 23 and 24. Further, it is not limited to a single part for the multiplication display part 25, a plurality of display parts may be provided for the multiplication display part 25.

As described in the aforementioned embodiments, the following features may be included.

This gaming machine comprises: identification symbol display means (for example, a variable display part) for displaying identification symbols variably and stopping such variable display; privilege symbol display means (for example, a multiplication display part) for displaying privilege symbols (for example, multiplication symbols) variably and stopping such variable display; winning determination means (for example, a CPU or a winning determination part) for determining whether or not a combination of identification symbols being displayed along a pay line by the identification symbol variable display means matches a predetermined combination when the variable display of the identification symbols is stopped; and payout determination means (for example, a CPU or payout determination part) for determining an amount of game value to be paid out to a player based on a payout rate of the predetermined combination when the winning determination means determines that the combination of identification symbols displayed along the pay line matches the predetermined combination, and a special benefit of a privilege symbol displayed at a position corresponding to the pay line by the privilege symbol variable display means when the variable display of the privilege symbols is stopped.

Here, the “privilege symbol” means a symbol to which information to increase and/or magnify the payout amount determined by the identification symbols is assigned, and such information to increase and/or magnify the amount may include a multiplication factor, an additional point and the like.

In such a gaming machine, even though the payout rate determined by the identification symbols is small, it is possible to obtain a large amount of payout by adding a special benefit according to the privilege symbol such that it is possible to keep the player's expectation for the large amount of payout even if a winning combination having been displayed in a stationary manner does not correspond to a winning combination with a high rank (high payout rate).

In the above-described gaming machine, the privilege symbol is a multiplication symbol indicating a multiplication factor to be multiplied by the payout rate to determine the value of the game value to be paid out to the player, and the payout determination means may be configured such that the value of the game value to be paid out to the player may be determined by multiplying the payout value by the multiplication factor indicated by the multiplication symbol.

In such a gaming machine, since a large amount of payout can be expected because of the multiplication factor to be applied even though a displayed combination matches a low-ranked winning combination, it is possible to keep the player's expectation for the payout amount even if the displayed combination of symbols does not include winning combinations with high payout rates.

In the above-described gaming machine according to the present invention, it is characterized in that the identification symbol display means may include a plurality of reel means and that the privilege symbol display means may include reel means disposed on either side of the plurality of reels. In such a gaming machine, it is possible to keep the player's expectation for the payout amount until the last reel stops even if the displayed combination of symbols does not include winning combinations with high payout rates.

Also, in the above-described gaming machine according to the present invention, it is characterized in that the identification symbols may include at least one special symbol (for example, a wild symbol), which is treated by the winning determination means as a symbol equivalent to at least one of the other kinds of identification symbols, and that such special symbol is expanded when the special symbol is displayed at the end of the variable display of the identification symbols.

In such a gaming machine, it is possible to increase the probability to win by expanding the special symbol so as to increase the player's expectation. Here, “expanding” means to show visually that the gaming machine handles adjacent areas to the special symbol (core symbol) as the areas showing equivalent symbols to the special symbol and includes not only expanding/stretching the special symbol geometrically, but also generating a plurality of special symbols such as copying the same and splitting the same.

Also, the above-described gaming machine may be characterized by comprising a transparent liquid crystal panel (for example, a lower liquid crystal display) being provided in front of the identification symbol display means wherein the transparent liquid crystal panel may be characterized by displaying an effect image showing an expanded special symbol.

In such a gaming machine, it is possible to perform a completely new effect, which cannot be achieved by the conventional mechanical reels (mecha reels).

The following features may also be included.

Thus, a gaming machine comprises a variable display device including an identification symbol display part for displaying identification symbols variably and stopping such variable display and a privilege symbol display part for displaying privilege symbols variably and stopping such variable display; and a control device for determining whether or not a combination of identification symbols being displayed along a pay line by the identification symbol variable display part matches a predetermined combination when the variable display of the identification symbols is stopped. The control device determines an award to a player based on a payout rate of the predetermined combination when the combination of identification symbols displayed along the pay line matches the predetermined combination, and a special benefit of a privilege symbol displayed at a position corresponding to the pay line by the privilege symbol variable display part when the variable display of the privilege symbols is stopped.

Here, the term “award” corresponds to the amount of game value to be paid out to the player.

Also, the privilege symbol is a multiplier symbol indicating a multiplication factor and the control device determines the award to the player by multiplying the payout rate by the multiplication factor. Here, the multiplier symbol may include a combination of a figure and an operation symbol such as “10×.”

The identification symbol display part may comprise an array of a plurality of reels; and the privilege symbol display part may comprise a reel which is arranged on either side of the array of the plurality of reels.

The plurality of identification symbols may also include at least one substitute symbol that is treated as an equivalent symbol to at least one of the other plurality of identification symbols. The at least one substitute symbol is expanded when the at least one substitute symbol is displayed as the variable display of the identification symbols is stopped. The substitute symbol may correspond to a so-called wild symbol and be treated as any kind of identification symbol positioned on the activated pay line so as to constitute the winning combination. Thus, when the substitute symbol is determined to be on the activated pay line due to the expansion of the substitute symbol, the winning combination determination depends on the other identification symbols aligned on the activated pay line as these identification symbols are displayed in a stationary manner.

According to the present invention, since a large amount of payout can be expected even though the obtained winning combination is ranked low because the multiplication factor is multiplied to the payout rate, it is possible to keep the player's expectation until the last reel stops even though a symbol displayed in a stationary manner on the reel which stops first does not constitute a winning combination of symbols that corresponds to a high payout rate so as to enhance the player's desire toward the game.

Also, in another aspect of the present invention, the wild symbol may be expanded to increase the probability to obtain the winning combination such that it is possible to enhance the player's expectation. Also, it is possible to perform a completely new effect, which cannot be performed by only the conventional mechanical reels (mecha reels), by showing the effect image of the expanded wild symbol, thereby attracting the game players.

For example, it is also possible to provide a gaming machine that provides the player with a payout amount obtained by multiplying an original payout rate by a multiplication factor determined by a lottery when the winning combination is established if a certain condition is satisfied as a notification lamp is disposed on the side of a display window that is an opening through which symbols on reels are recognized. Here, a figure such as “×5”, which means the multiplication is five times, indicating the multiplication factor is displayed next to the notification lamp. Also, a display part comprising a seven-segment LED as a light source is provided below the display window. The display part displays the multiplication in the “figure” determined by the lottery when the winning combination is established under a predetermined condition.

In the gaming machine where multiplication having been determined by a lottery is shown at once, it is immediately recognized if the multiplication is given or not by seeing the lamp turned on or kept off such that the player's expectation for the game may diminish and it may be difficult to maintain the player's feeling toward the game.

However, in the aforementioned embodiments, it is possible to keep the player's feeling toward the game.

What is claimed is:

1. A gaming machine comprising:
a variable display device including an identification symbol display part for displaying identification symbols variably and stopping such variable display and a privilege symbol display part for displaying privilege symbols variably and stopping such variable display;
a control device for determining whether or not a combination of identification symbols being displayed along a pay line by the identification symbol variable display part matches a predetermined combination when the variable display of the identification symbols is stopped;
wherein the control device determines an award to a player based on a payout rate of the predetermined combination when the combination of identification symbols displayed along the pay line matches the predetermined combination, and a special benefit of a privilege symbol displayed at a position corresponding to the pay line by the privilege symbol variable display part when the variable display of the privilege symbols is stopped.

2. The gaming machine according to claim 1,
wherein the privilege symbol is a multiplier symbol indicating a multiplication factor and
wherein the control device determines the award to the player by multiplying the payout rate by the multiplication factor.

3. The gaming machine according to claim 1,
wherein the identification symbol display part comprises an array of a plurality of reels; and
wherein the privilege symbol display part comprises a reel which is arranged on either side of the array of the plurality of reels.

4. The gaming machine according to claim 1,
wherein the plurality of identification symbols include at least one substitute symbol that is treated as an equivalent symbol to at least one of the other plurality of identification symbols, and
wherein the at least one substitute symbol is expanded when the at least one substitute symbol is displayed as the variable display of the identification symbols is stopped.

5. The gaming machine according to claim 4, comprising a transparent liquid crystal panel being disposed in front of the identification symbol display part wherein the transparent liquid crystal panel displays an effect image formed by expanding the substitute symbol.
